(19) United States
(12) Patent Application Publication
(10) Pub. No.: US 2024/0274935 A1
(43) Pub. Date: Aug. 15, 2024

(54) BATTERY LID AND BATTERY

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Tsuyoshi EHARA, Toyota-shi (JP); Yozo UCHIDA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Yasuaki NAGANO, Kosai-shi (JP); Shigeru MATSUMOTO, Toyohashi-shi (JP)

(21) Appl. No.: 18/418,342

(22) Filed: Jan. 22, 2024

(30) Foreign Application Priority Data
Feb. 14, 2023 (JP) 2023-020855

(51) Int. Cl. H01M 50/162; H01M 50/15; H01M 50/553; H01M 50/564

(52) U.S. Cl. CPC H01M 50/162; H01M 50/15; H01M 50/553; H01M 50/564

(57) ABSTRACT

A battery lid includes an aluminum lid member, a first terminal member made of aluminum and a second terminal member made of copper, each extending to both a front side and a back side, and resin members fixing the terminal members to the lid member. Of the second terminal member, an opposite surface that faces a wall surface between the front side and the back side of the lid member via the resin member is formed with asperities, in which the resin member bites to form a minute anchor structure. The resin member is made of a base resin mixed with fillers and prepared so that its linear expansion coefficient in a range of 80% to 120% of a linear expansion coefficient of the aluminum.

### CROSS-REFERENCE TO RELATED APPLICATIONS

This application is based upon and claims the benefit of priority to Japanese Patent Application No. 2023-020855 filed on Feb. 14, 2023, the entire contents of which are incorporated herein by reference.

### BACKGROUND

### Technical Field

The present disclosure relates to a battery lid and a battery.

### Related Art

At terminal sections of a battery, terminal members are exposed on the outer side of an outer case. The terminal members are connected to electrode plates inside the battery. That is, the terminal members are provided extending outside and inside of the outer casing. The terminal sections are usually provided in a lid member of the outer case. An insulating member is provided between the lid member and each of the terminal members. The insulating members are made of resin. Accordingly, each terminal section includes a bonding portion between metal and resin. For such a bonding portion, the “metal-resin combined structure” technique, disclosed in Japanese unexamined patent application publication No. 2014-223781 can be applied.

### SUMMARY

### Technical Problems

The lid member is formed, at each of the terminal sections, with a part through which the terminal member extends, or penetrates, to the inside and the outside. This part includes a wall surface surrounding the terminal member. When a temperature rises, this part of the lid member will expand due to thermal expansion. If the insulating member does not thermally expand as with the lid member, the bonding interface between the lid member and the insulating member will be subjected to tensile stress. Depending on the degree and frequency of occurrence of the tensile stress, unsticking or separation may take place between the insulating member and the lid member. Generally, a lid member of a battery is made of aluminum, and one terminal member is made of aluminum and the other terminal member is made of copper.

The present disclosure has been made to address the above problems and has a purpose to provide a battery lid in which a lid member and terminal members are insulated from each other by a resin member, and the lid member and the resin member are less likely to separate, i.e., come unstuck, from each other even if they are subjected to thermal history, and a battery incorporating this battery lid.

### Means of Solving the Problems

To achieve the above-mentioned purpose, one aspect of the present disclosure provides a battery lid comprising: a lid member made of aluminum; a first terminal member made of aluminum and a second terminal member made of copper, which are provided extending to both a front side and a back side of the lid member; and resin members fixing the first terminal member and the second terminal member to the lid member, wherein the second terminal member has an opposite surface that faces a wall surface between the front side and the back side of the lid member via one of the resin members, the opposite surface being formed with asperities, in which the resin member bites to form a minute anchor structure, the resin members are made of base resin mixed with fillers, and the resin members have a linear expansion coefficient in a range of 80% to 120% of a linear expansion coefficient of aluminum.

In the battery lid configured as above, the first terminal member and the resin member will expand and contract to approximately the same degree even when a temperature varies. Thus, at the location where the first terminal member is fixed to the lid member with the resin member, a gap is hardly generated between the lid member and the resin member, so that they will not separate from each other. In contrast, at the location where the second terminal member is fixed to the lid member with the resin member, the second terminal member will expand and contract to a slightly smaller degree than the resin part. However, the anchoring effect of the minute anchor structure acts at the contact portions of the second terminal member and the resin member, and therefore these second terminal member and resin member are less likely to separate.

In the battery lid configured as above, the first terminal member has an opposite surface that faces a wall surface between the front side and the back side of the lid member via the other of the resin members, the opposite surface of the first terminal member being formed with asperities, in which the resin member bites to form a minute anchor structure. This configuration enables the first terminal member and the resin part to be reliably bonded to each other.

In the battery lid according to any one of the above-described configurations, the lid member has an outer surface on the front side and an inner surface on the back side each formed with asperities in an area covered by the resin members, so that the resin members bite into the asperities of the lid member to form a minute anchor structure. This configuration enables the lid member and the resin part to be reliably bonded to each other.

In the battery lid according to any one of the above-described configurations, the fillers are made of glass.

The resin part can enhance the mechanical strength because of the base resin mixed with glass fillers. The linear expansion coefficient of this resin part can be adjusted according to a mixing ratio of glass.

In the battery lid according to any one of the above-described configurations, the base resin is polyphenylene sulfide resin. Polyphenylene sulfide resin is a relatively strong resin. The linear expansion coefficient of this resin part can be adjusted according to a mixing ratio of fillers.

Another aspect of the present disclosure provides a battery comprising: a case body having an opening; an electrode assembly housed in the case body; and a battery lid closing the opening of the case body, wherein the battery lid has any one of the above-described configurations, and the first terminal member and the second terminal member are each connected to electrode plates constituting the electrode assembly. In this battery, the resin part in the battery lid is less likely to separate, i.e., come unstuck, from the lid member.

According to the present disclosure, it is possible to provide a battery lid in which a lid member and a terminal member are insulated from each other by a resin part, and the lid member and the resin part are less likely to separate from each other even if they are subjected to thermal history, and a battery incorporating this battery lid.

### BRIEF DESCRIPTION OF THE DRAWINGS

FIG. 1 is a perspective view of a battery in an embodiment;

FIG. 2 is a cross-sectional view showing a structure of the portion which is one outer terminal of the battery; and

FIG. 3 is a cross-sectional view showing a structure of the portion which is the other outer terminal of the battery.

### DETAILED DESCRIPTION OF THE EXEMPLARY EMBODIMENTS

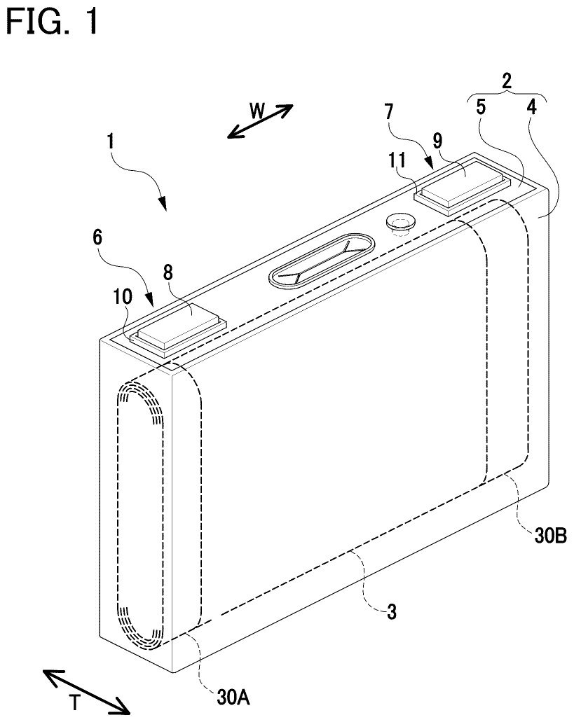

A detailed description of a battery 1 in an embodiment of this disclosure will now be given referring to the accompanying drawings. The battery 1 shown in FIG. 1 includes an outer case 2 and an electrode assembly 3. The outer case 2 includes a case body 4 and a lid member 5. The lid member 5 is provided with a positive outer terminal 6 and a negative outer terminal 7. When the battery 1 is viewed externally, at the portions of the outer terminals 6 and 7, terminal surfaces 8 and 9 and resin members 10 and 11 are visible.

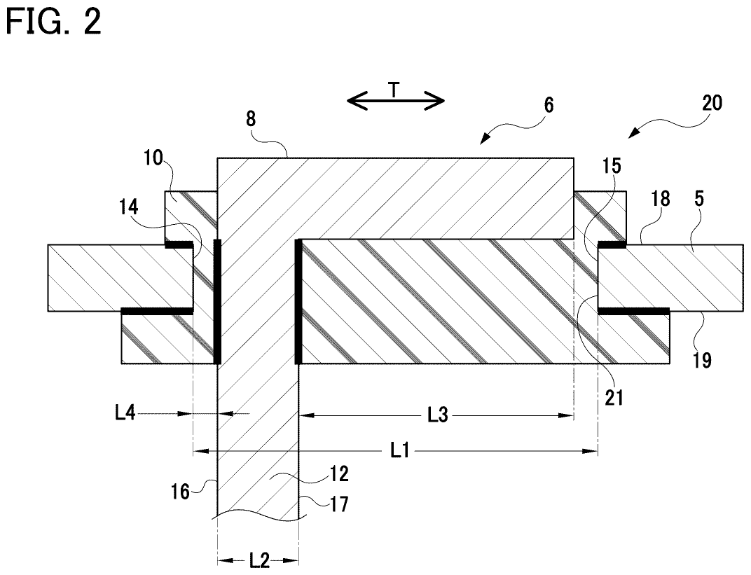

The structure of the portion corresponding to the outer terminal 6 will be described referring to FIG. 2. FIG. 2 is a vertical cross-sectional view of this structure cut in parallel to the thickness direction T in FIG. 1. As shown in FIG. 2, at the portion corresponding to the outer terminal 6, a first terminal member 12 is placed. The first terminal member 12 is provided extending to both the front side (the upper side in FIG. 2) and the back side (the lower side in FIG. 2) of the lid member 5. Both the lid member 5 and the first terminal member 12 are made of aluminum. The first terminal member 12 is connected to a positive electrode plate 30A of the electrode assembly 3 inside the outer case 2 (i.e., below the lid member 5 in FIG. 2). The terminal surface 8 in FIG. 1 is an exposed surface of the first terminal member 12, facing outward.

At the portion corresponding to the outer terminal 6, the lid member 5 is formed with a through hole 21 through which the first terminal member 12 is placed. As shown in FIG. 2, the lid member 5 includes wall surfaces 14 and 15 defining that through hole 21. The first terminal member 12 includes, below the terminal surface 8, opposite surfaces 16 and 17 each extending vertically in this figure. Each of the opposite surfaces 16 and 17 is part of the surface of the first terminal member 12. Specifically, the opposite surface 16 faces the wall surface 14 and the opposite surface 17 faces the wall surface 15. In the lid member 5, the upward-facing surface in FIG. 2 is referred to as an outer surface 18 and the downward-facing surface in FIG. 2 is referred to as an inner surface 19. A gap or space between the lid member 5 and the first terminal member 12 in FIG. 2 is sealed with the resin member 10. This resin member 10 insulates the first terminal member 12 from the lid member 5 and further separates the interior space of the outer case 2 from the exterior space.

In the structure in FIG. 2, a minute anchor structure is formed at contact portions of the lid member 5 and the resin member 10 and also a minute anchor structure is formed at contact portions of the first terminal member 12 and the resin member 10. Specifically, the minute anchor structure is formed in an area of the outer surface 18 and an area of the inner surface 19 of the lid member 5, the areas being covered by the resin member 10, and areas of the opposite surfaces 16 and 17 of the first terminal member 12, the areas being covered by the resin member 10. In FIG. 2, the locations of the minute anchor structure are indicated by thick lines. Of the opposite surfaces 16 and 17, the portions facing the wall surfaces 14 and 15 via the resin member 10 are also formed with the minute anchor structure. In the minute anchor structure, the surface of each metal member (i.e., the lid member 5 and the first terminal member 12) is a roughened surface with minute asperities (pits and projections). The resin material of the resin member 10 bites into these asperities, exhibiting the anchoring effect.

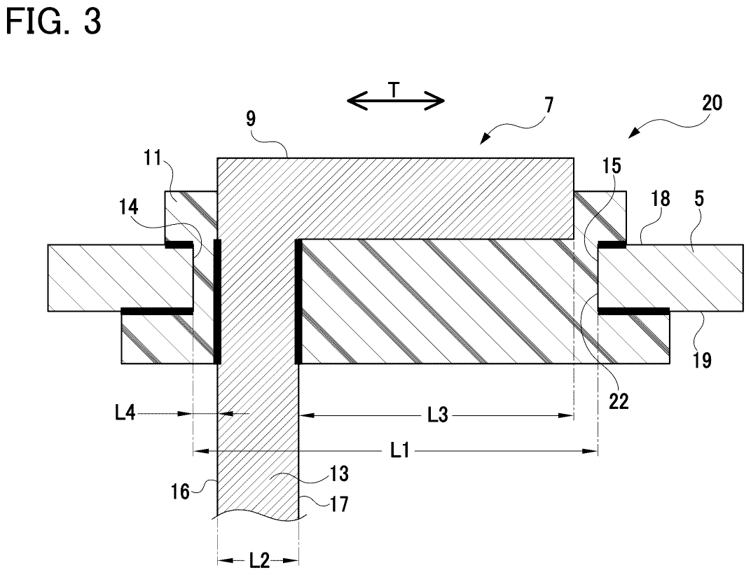

FIG. 3 shows the structure of the portion corresponding to the outer terminal 7. The members shown in FIG. 3 are identical in shape to those in FIG. 2. However, the second terminal member 13 in FIG. 3 is made of copper and connected to a negative electrode plate 30B of the electrode assembly 3. The terminal surface 9 in FIG. 1 is an exposed surface of the second terminal member 13, facing outward. The opposite surfaces 16 and 17 of the second terminal member 13 are identical to those of the first terminal member 12 shown in FIG. 2. At the contact portions of the lid member 5 and the resin member 10 and at the contact portions of the second terminal member 13 and the resin member 10 in FIG. 3, corresponding to the locations of the minute anchor structure in FIG. 2, a minute anchor structure is formed similarly.

An assembly of the lid member 5 fixed with the first terminal member 12 and the second terminal member 13 via the resin members 10 and 11 as shown in FIGS. 2 and 3 is referred to as a battery lid 20. In the battery 1 in FIG. 1, this battery lid 20 closes the opening of the case body 4 in which the electrode assembly 3 is housed.

The resin members 10 and 11 are described in detail below. Each of these members is made of a composite resin mixed with fillers in a base resin. The base resin may be selected from polyphenylene sulfide resin (PPS), polyarylene sulfide (PAS), and others. The fillers may be selected from glass, alumina, potassium titanate, and others. In the following description, the base resin is PPS resin and the fillers are glass fillers.

The fillers are mixed into the base resin for two purposes: one is to enhance the mechanical strength of the resin members 10 and 11, and the other is to adjust the thermal expansion rate. The present disclosure mainly targets the latter purpose of adjusting the thermal expansion rate. The resin members 10 and 11 in the present embodiment are made of composite resin having such an adjusted mixing ratio of fillers as that the linear expansion coefficient of thermal expansion becomes approximately equal to the linear expansion coefficient of the lid member 5, i.e., aluminum material.

The linear expansion coefficient in the present disclosure indicates a linear expansion coefficient in a temperature range where the battery 1 is generally used. The temperature region where the battery 1 is used is broadly determined as a region of about −40° C. to about 65° C., in which a region of about 25° C. to about 60° C. is frequently used. The linear expansion coefficient of each material constituting the battery lid 20 at 20° C. is approximately as listed below, even though they may slightly vary depending on minor component elements, forming methods, and other factors.
PPS resin (no filler mixed): 49.0×10⁻⁶/K
Aluminum: 24.1×1010⁻⁶/K
Copper: 18.0×10⁻⁶/K

Specifically, the linear expansion coefficient of aluminum is larger than the linear expansion coefficient of copper, and the linear expansion coefficient of PPS resin used as the base resin is even larger. The linear expansion coefficient of composite resin made by mixing fillers into PPS resin is smaller than the linear expansion coefficient of PPS resin used as the base resin. This linear expansion coefficient of composite resin can be further reduced by increasing the mixing ratio of fillers. By this method, the linear expansion coefficient of the resin parts 10 and 11 is adjusted to a range of 80% to 120% of the linear expansion coefficient of aluminum.

In the battery lid 20 in the present embodiment, the linear expansion coefficient of the resin members 10 and 11 are close to the linear expansion coefficient of the aluminum constituting the lid member 5 and the first terminal member 12. Therefore, even when the temperature varies, the lid member 5 and the resin members 10 and 11 are less likely to separate from each other. Also, the first terminal member 12 and the resin members 10 and 11 are less likely to separate from each other.

This is described below referring to the portion corresponding to the outer terminal 6 in FIG. 2. In FIG. 2, the distance between the wall surface 14 and the wall surface 15 of the lid member 5 is defined as a length L1, in which the length of the first terminal member 12, that is, the thickness of the first terminal member 12 in FIG. 2, is denoted by L2. Of the through hole 21 of the lid member 5, through which the first terminal member 12 extends, the portions occupied with the resin member 10 are defined as a right portion with a length L3 relative to the first terminal member 12 and a left portion with a length L4. The sum of the lengths L2, L3, and L4 is equal to the length L1 at normal temperatures (for example, about 20° C.).

When the linear expansion coefficient of the resin part 10 is equal to the linear expansion coefficient of the aluminum, even when the temperature rises or descends, the length L1 of the through hole 21 of the lid member 5 in FIG. 2, the length L2 of the first terminal member 12, and the lengths L3 and L4 of the resin member 10 will expand or contract to the same degree. Thus, no gap is generated between the lid member 5 and the resin member 10 and between the resin member 10 and the first terminal member 12. Even if the linear expansion coefficient of the resin member 10 is not exactly equal to the linear expansion coefficient of the aluminum, the resin member 10 is not likely to separate from aluminum members as long as the its linear expansion coefficient is within the aforementioned range. This is because the resin member 10 has a certain degree of flexibility despite being made relatively hard by addition of fillers.

Further, the portion corresponding to the outer terminal 7 is considered referring to FIG. 3. The reference signs L1, L2, L3, and L4 are defined as those in FIG. 2. In FIG. 3, however, the second terminal member 13 is made of copper, not aluminum. In this case, the length L1 of the through hole 22 of the lid member 5 in FIG. 3, and the lengths L3 and L4 of the resin member 11 will expand and contract to the same degree. Thus, no gap will occur between the lid member 5 and the resin member 11. However, the degrees of expansion and contraction of the length L2 of the second terminal member 13 are slightly smaller than those of the length L1 and the lengths L3 and L4.

The situation where the temperature rises will be considered first. In this situation, the expansion degree of the length L2 is slightly smaller than those of the lengths L1, L3, and L4. This is a factor that can cause a slight gap to occur between the resin member 11 and each of the opposite surfaces 16 and 17 of the second terminal member 13, but does not actually cause separation between the resin part 11 and each of the opposite surfaces 16 and 17. This is because of some flexibility of the resin member 11 and the minute anchor structure formed in the opposite surfaces 16 and 17 of the second terminal member 13.

Further, the situation where the temperature descends will be considered. In this situation, the lengths L3 and L4 of the resin member 11 and the length L1 of the through hole 22 of the lid member 5 will contract to the same degree. Therefore, no gap will occur between the resin member 11 and the wall surfaces 14 and 15 of the lid member 5. At that time, the contraction degree of the length L2 of the second terminal member 13 is slightly gentler than those of the lengths L1, L3, and L4, but this rather means that the resin member 11 and the opposite surfaces 16 and 17 of the second terminal member 13 lightly press against each other. Thus, the resin member 11 and the opposite surfaces 16 and 17 will not separate from each other.

For comparison, the cases where the linear expansion coefficients of the resin members 10 and 11 are departed from the aforementioned ranges are also considered. A first discussion is made about the case where the linear expansion coefficients of the resin members 10 and 11 are larger than the upper limit of the above-mentioned range, that is, the mixing ratio of fillers is insufficient. In this case, when the temperature descends, the resin members 10 and 11 and the wall surfaces 14 and 15 of each through holes 21 and 22 of the lid member 5 are likely to separate. This is because the lengths L3 and L4 of each of the resin members 10 and 11 are excessively reduced as compared with the shrinking of the length L1 of the through hole 21 of the lid member 5. When the temperature rises, in contrast, the lengths L3 and L4 of each resin member 10 and 11 excessively expand as compared with the enlargement of the length L1 of the through hole 21 of the lid member 5. This situation itself indicates that each of the resin members 10 and 11 and the wall surfaces 14 and 15 press against each other. However, if the difference in expansion is too large, it may lead to breakage of the resin members 10 and 11 due to shear stress in a direction parallel to the interface between the resin members and the wall surfaces.

Furthermore, the case where the linear expansion coefficients of the resin members 10 and 11 are smaller than the lower limit of the above-mentioned range, that is, the mixing ratio of fillers is excessive, are considered below. In this case, the linear expansion coefficient of each of the resin members 10 and 11 is even smaller than the linear expansion coefficient of the aluminum and close to that of the copper. In the case where the temperature rises, therefore, the expansion of the lengths L3 and L4 of each of the resin members 10 and 11 is less than the expansion of the length L1 of the through holes 21 and 22 of the lid member 5. This may cause separation, or unsticking, between each of the resin members 10 and 11 and the wall surfaces 14 and 15.

In contrast, in the battery lid 20 in the present embodiment with the resin members 10 and 11 whose linear expansion coefficient has been adjusted to be approximately equal to the linear expansion coefficient of the aluminum, irrespective of during the temperature rise or temperature descend, and irrespective of the portions of the outer terminal 6 or the outer terminal 7, each of the resin members 10 and 11 and the wall surfaces 14 and 15 will hardly separate, i.e., come unstuck, from each other.

According to the present embodiment described in detail above, the resin members 10 and 11 are made of the composite resin prepared by mixing fillers in a base resin, and the mixing ratio of the fillers is adjusted so that the linear expansion coefficient of the composite resin is approximately equal to the linear expansion coefficient of the aluminum. With this configuration and the minute anchor structure provided between the opposite surfaces 16 and 17 of the second terminal member 13 and the resin part 11, the battery lid 20 and the battery including such the battery lid 20 can be provided in which the lid member 5 and the terminal members 12 and 13 are insulated by the resin members 10 and 11, and the lid member 5 and the resin members 10 and 11 are less likely to separate, i.e., come unstuck, from each other even when subjected to thermal history.

The foregoing embodiments are mere examples and give no limitation to the present disclosure. The present disclosure may be embodied in other specific forms without departing from the essential characteristics thereof. For example, the minute anchor structure may be provided only one of the outer surface 18 and the inner surface 19 of the lid member 5. However, the minute anchor structures formed in both of those surfaces 18 and 19 can achieve more enhanced joining strength between the resin members 10 and 11 and the metal members (i.e., the lid member 5, the first terminal member 12, and the second terminal member 13) in each of the portions of the outer terminals 6 and 7 than the above single minute anchor structure.

The linear expansion coefficient of the resin member 10 and the linear expansion coefficient of the resin member 11 need not be the same. For example, it may be arranged such that the linear expansion coefficient of the resin member 11 is set smaller than the linear expansion coefficient of the resin member 10 (that is, the linear expansion coefficient of the resin member 11 is close to the linear expansion coefficient of the copper) within the range of the linear expansion coefficients of the resin members 10 and 11 adjusted above. Moreover, the cross-sectional views in FIGS. 2 and 3 are vertical cross-sectional views parallel to the thickness direction T in FIG. 1, but not limited thereto. Alternatively, the battery 1 may have the configuration shown in FIGS. 2 and 3 when seen in vertical cross-sectional views parallel to the width direction W in FIG. 1.

### REFERENCE SIGNS LIST

1 Battery

2 Outer case

3 Laminated electrode body

4 Case body

5 Lid member

6 Outer terminal

7 Outer terminal

8 Terminal surface

9 Terminal surface

10 Resin member

11 Resin member

12 First terminal member

13 Second terminal member

14 Wall surface

15 Wall surface

16 Opposite surface

17 Opposite surface

18 Outer surface

19 Inner surface

What is claimed is:

1. A battery lid comprising:
a lid member made of aluminum;
a first terminal member made of aluminum and a second terminal member made of copper, which are provided extending to both a front side and a back side of the lid member; and
resin members fixing the first terminal member and the second terminal member to the lid member,
wherein the second terminal member has an opposite surface that faces a wall surface between the front side and the back side of the lid member via one of the resin members, the opposite surface being formed with asperities, in which the resin member bites to form a minute anchor structure,
the resin members are made of base resin mixed with fillers, and
the resin members have a linear expansion coefficient in a range of 80% to 120% of a linear expansion coefficient of aluminum.

2. The battery lid according to claim 1, wherein the first terminal member has an opposite surface that faces a wall surface between the front side and the back side of the lid member via the other of the resin members, the opposite surface of the first terminal member being formed with asperities, in which the resin member bites to form a minute anchor structure.

3. The battery lid according to claim 1, wherein the lid member has an outer surface on the front side and an inner surface on the back side each formed with asperities in an area covered by the resin members, so that the resin members bite into the asperities of the lid member to form a minute anchor structure.

4. The battery lid according to claim 2, wherein the lid member has an outer surface on the front side and an inner surface on the back side each formed with asperities in an area covered by the resin members, so that the resin members bite into the asperities of the lid member to form a minute anchor structure.

5. The battery lid according to claim 1, wherein the fillers are made of glass.

6. The battery lid according to claim 2, wherein the fillers are made of glass.

7. The battery lid according to claim 3, wherein the fillers are made of glass.

8. The battery lid according to claim 4, wherein the fillers are made of glass.

9. The battery lid according to claim 1, wherein the base resin is polyphenylene sulfide resin.

10. The battery lid according to claim 2, wherein the base resin is polyphenylene sulfide resin.

11. The battery lid according to claim 3, wherein the base resin is polyphenylene sulfide resin.

12. The battery lid according to claim 4, wherein the base resin is polyphenylene sulfide resin.

13. The battery lid according to claim 5, wherein the base resin is polyphenylene sulfide resin.

14. The battery lid according to claim 6, wherein the base resin is polyphenylene sulfide resin.

15. The battery lid according to claim 7, wherein the base resin is polyphenylene sulfide resin.

16. The battery lid according to claim 8, wherein the base resin is polyphenylene sulfide resin.

17. A battery comprising:
a case body having an opening;
an electrode assembly housed in the case body; and
a battery lid closing the opening of the case body,
wherein the battery lid is configured according to claim 1, and
the first terminal member and the second terminal member are each connected to electrode plates constituting the electrode assembly.

18. The battery according to claim 17, wherein the first terminal member has an opposite surface that faces a wall surface between the front side and the back side of the lid member via the other of the resin members, the opposite surface of the first terminal member being formed with asperities, in which the resin member bites to form a minute anchor structure.

19. The battery according to claim 17, wherein the lid member has an outer surface on the front side and an inner surface on the back side each formed with asperities in an area covered by the resin members, so that the resin members bite into the asperities of the lid member to form a minute anchor structure.

20. The battery according to claim 17, wherein the fillers are made of glass.
